(19) United States
(12) Patent Application Publication
(10) Pub. No.: US 2026/0015366 A1
(43) Pub. Date: Jan. 15, 2026

(54) LIGANDS FOR LITHIUM DETECTION OR EXTRACTION FROM FLUIDS AND LITHIUM COMPLEXES COMPRISING THE SAME

(71) Applicant: Countertrace LLC, Manvel, TX (US)

(72) Inventors: Robert E. Hanes, Manvel, TX (US); James Allensworth, Manvel, TX (US); Richard L. Pettys, Manvel, TX (US); David M. Headley, Manvel, TX (US); Paul T. Hoopingarner, Manvel, TX (US)

(73) Assignee: Countertrace LLC, Manvel, TX (US)

(21) Appl. No.: 19/334,219

(22) Filed: Sep. 19, 2025

Related U.S. Application Data
(63) Continuation of application No. PCT/US2024/020947, filed on Mar. 21, 2024.
(60) Provisional application No. 63/491,632, filed on Mar. 22, 2023.

(51) Int. Cl. C07F 5/02; C08J 7/14

(52) U.S. Cl. CPC C07F 5/025; C08J 7/14

(57) ABSTRACT

Ligands capable of complexing hydrated lithium ions may comprise at least one arylboronic acid internally complexed with a heteroatom, such as via internal complexation with an amine, ether, or carbonyl to define a 5- or 6-membered ring. The arylboronic acid may be covalently bonded to a substrate via a linker moiety when accomplishing the foregoing, or the linker moiety may contain a reactive functionality capable of forming a covalent bond to a substrate or other group. The linker moiety may be further covalently bonded to an anionic functional group, such as a second arylboronic acid internally complexed with a second heteroatom. Ligands may also comprise at least one arylboronic acid internally complexed with a heteroatom, wherein the ligand is further covalently bonded to a molecule that undergoes a spectroscopic or electrochemical change in the presence of lithium ions. Substrate-bound or substrate-free lithium complexes may be formed using the ligands.

### BACKGROUND

Interest in extracting lithium from other metals has exploded in recent years due to the ever-increasing use of lithium-ion batteries in various technologies. At present, lithium is most frequently obtained commercially from evaporation of salt flat brines, followed by chemical conversion of the salt residue into a form from which lithium can be separated from other salts. Geothermal brines and produced oilfield water may also comprise lithium in commercially significant amounts (e.g., 200-2000 ppm for geothermal brines and as little as approximately 40 ppm for produced oilfield water). In some instances, lithium may be isolated from lithium-containing ores, such as spodumene, through processes including crushing, roasting, and acid leaching. Isolation of lithium from salt flat brines and lithium-containing ores and similar lithium sources are frequently energy intensive and may generate significant quantities of chemical waste. In addition, salt flat brines are often rather acidic, which may further complicate isolation and quantification of lithium.

In salt flat brines and similar lithium-containing aqueous fluids, lithium is often present as a minority component in combination with other salts, such as sodium and potassium salts. Direct isolation of lithium from aqueous fluids, such as salt flat brines, would be desirable to overcome the foregoing challenges; however, high-efficiency binding of lithium ions in preference to other metal ions has not yet been realized.

Thorin is an arsenic-containing indicator that is capable of binding lithium in aqueous fluids. However, Thorin only binds lithium at relatively high lithium to ligand ratios and at pH values greater than about 12. For at least these reasons, in addition to the undesirable presence of arsenic, Thorin is impractical for large-scale isolation of lithium.

Although supramolecular constructs, such as crown ethers, have been successfully designed and synthesized for complexing sodium and potassium cations, similar supramolecular entities selective for lithium have not yet been realized, despite considerable effort to do so. Usually, supramolecular constructs having a binding site sized to accommodate lithium ions (based on the known ionic radius of lithium) instead tend to complex sodium ions.

Without being bound by theory or mechanism, the reason for the foregoing discrepancy is that lithium ions exist in aqueous fluids in hydrated form as a robust tetrahedral complex containing four water ligands. The tetrahedral complex has been verified through extensive experimental and theoretical studies. Such “hydrated lithium ions” have a much larger effective atomic radius than does a naked lithium cation. In fact, the effective hydrated radius of lithium cations is larger than that of sodium cations (3.8 Å for Li⁺ compared to 3.6 Å for Na⁺), despite naked lithium ions having a considerably smaller ionic radius than do sodium ions. Even if supramolecular constructs are designed with a binding site tuned to the hydrated radius of lithium ions, the coordinated water molecules are very difficult to displace to promote complexation of lithium as a result of the strong preference for lithium to remain hydrated, despite the entropic gains that might be realized by releasing one or more of the coordinated water molecules and forming coordinated lithium. Moreover, while the formal charge of the central lithium ion in hydrated lithium ions is +1, given that water is a neutral ligand and lithium is a Group 1 metal, theoretical calculations reveal the effective (calculated) charge on lithium may be considerably lower, thereby altering the binding affinity of lithium toward various other ligands away from the behavior that might otherwise be expected. The low effective charge upon hydrated lithium ions may also be reflective of strong electron donation of the water ligands to the lithium ion, wherein the strong electron donation aids in maintaining the water ligands in a tightly bound state.

Another difficulty associated with direct lithium binding in aqueous fluids is that supramolecular constructs and other hydrophobic ligands often have limited solubility in aqueous fluids and are frequently deployed in water-immiscible organic solvents. Such organic solvents may present undesirable environmental or human health concerns that may render them unsuitable for use in commercial processes. The foregoing solvent immiscibility further complicates the problem of extracting lithium ions from aqueous fluids, as it may be difficult to achieve sufficient contact between the lithium ions and the ligand at the organic-water interface. Thus, even for the limited suite of ligands that do bind lithium ions, it may be difficult to achieve satisfactory lithium binding while operating in an all-aqueous environment. Furthermore, ligand-bound lithium ions may remain admixed with a fluid phase, which may necessitate a separate precipitation or solvent removal step to facilitate isolation of the lithium for further processing thereof and potential reuse of the ligand. The foregoing difficulties may further render problematic the detection and quantification of lithium within aqueous fluids.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, as will occur to one having ordinary skill in the art and having the benefit of this disclosure.

FIG. 1 is an FTIR spectrum of the product obtained from the benzene solution of Example 1 in comparison to that of alizarin.

FIG. 2 is a UV-VIS spectrum of the product obtained from the reductive amination reaction of Example 2 in comparison to that of alizarin.

FIG. 3 is a Beer's Law plot of absorbance as a function of Li⁺ concentration in water in the presence of the product of Example 2.

### DETAILED DESCRIPTION

The present disclosure relates to complexation of metal ions within aqueous fluids and, more particularly, to lithium complexation, including ligand-based detection or separation of lithium ions within aqueous fluids through formation of a lithium complex.

As discussed above, direct isolation of lithium ions from aqueous fluids, such as salt flat brines and other sources containing lithium, is rendered problematic by the co-presence of other salts and the formation of hydrated lithium ions. Difficult removal of the water ligands from hydrated lithium ions significantly complicates ligand design and binding efficacy thereof. Moreover, water insolubility of many designed ligands based upon organic scaffolds may render exceedingly problematic the separation of lithium ions from aqueous fluids through formation of a lithium complex. The foregoing may complicate the detection of lithium ions as well.

In the present disclosure, the terms “coordination” and “complexation” and grammatical forms thereof are used interchangeably. Each of these terms refers to direct or indirect bonding of a lithium ion with one or more donor atoms within a suitable ligand. Direct coordination (complexation) may occur through formation of a coordinate covalent bond. In a coordinate covalent bond, the lithium ion is electron-deficient, and one or more donor atoms within a ligand may donate a pair of electrons for forming the coordinate covalent bond. In an extreme case, this may even amount to an ionic bond. Indirect complexation may occur through a molecular association, such as hydrogen bonding, occurring between a water ligand and one or more donor atoms within another ligand.

The terms “substrate” and “surface” may be used interchangeably herein.

In response to the foregoing challenges, the present disclosure provides ligands that may bind lithium ions through formation of a lithium complex and optionally may be readily configured for immobilization upon a substrate via covalent bonding, wherein the substrate may comprise a solid support (e.g., a polymer surface, a glass surface, a metal surface, a ceramic surface or the like) or a hydrated polymer support that is at least partially soluble or dispersed in an aqueous fluid. In addition to binding lithium, a key advantage itself, the binding may be highly selective for lithium ions over sodium ions and other alkali metal ions, in contrast to the behavior of crown ethers and other supramolecular constructs. Immobilization of the ligands upon a substrate may further overcome the issues frequently associated with the hydrophobicity (and resulting water insolubility) of designed organic ligands. The substrate may essentially replace the organic solvent (e.g., as a carrier for the ligand) that may commonly be used when forming complexes using designed organic ligands. Although supported ligands may be advantageous in some cases, unsupported ligands may also be used in the disclosure herein. For unsupported ligands of the present disclosure (ligands not bound to a substrate), introduction of an organic solvent (e.g., a water-miscible organic solvent) or a polyethyleneglycol surfactant to a medium containing lithium ions may increase the binding efficiency with which the ligand forms a lithium complex.

Advantageously, once a lithium ion has been complexed by a ligand immobilized upon a substrate that is a solid support, the solid support and its complexed/bound lithium ions may be easily separated from the aqueous fluid and components remaining therein. The lithium ions may then be recovered through decomplexation from the solid support and thereafter undergo further processing or refinement. In another embodiment, the substrate may comprise a hydrated polymer, wherein the hydrated polymer may or may not be completely soluble in water. Such substrates may be favorable for sensor applications, where a confined space is to be probed optically or electrically. As discussed further below, a dye or similar indicator molecule may be associated with the substrate or ligand, either in covalently bonded or non-covalently bonded form, to facilitate spectroscopic or electrochemical detection of the binding of lithium ions upon the substrate. Such bound ligands may also define the active element of a sensor capable of detecting lithium ions in some cases, such as when covalently bonded to a substrate cast as a thin-film.

Although substrate-bound ligands may be advantageous in certain circumstances, ligands of the present disclosure may also be synthesized and utilized in a free form that may optionally be further covalently bonded to a compound that produces an analytical response when the ligands are complexed to a lithium ion. The compound may be a dye, indicator, or similar moiety that is capable of producing a detectable spectroscopic or electrochemical response once the ligand is complexed to a lithium ion. Such ligands may be used for detection and quantification of lithium ions within aqueous fluids or complex fluids containing organic compounds. Optionally, the ligands may be further disposed upon a substrate, optionally being covalently bonded to the substrate, to provide the active portion of a sensor capable of detecting lithium ions. The sensors may be plate-based or flow-through sensors, for example. Substrate-bound ligands containing a covalently bonded dye or indicator may also be advantageous when used for extracting lithium ions, as the spectroscopic or electrochemical signature may be monitored to determine when extraction is complete, such as when all the lithium binding sites upon the substrate have been filled.

The ligands of the present disclosure may be pre-organized in an entropically favorable structure designed to promote complexation of a lithium ion in a tetracoordinate geometry having four metal-ligand bonds, which may be direct or indirect to the lithium ion. The pre-organization may be accomplished through chemical synthesis to achieve restriction of available degrees of freedom of molecular motion with geometric molecular constraints, such as ring formation or a steric blocking group. The tetracoordinate geometry may be tetrahedral or distorted tetrahedral. Alternately, the tetracoordinate geometry may be square planar or see-saw. By pre-organizing the ligand, displacement of one or more of the coordinated water ligands upon the lithium ion may become more energetically and enthalpically favorable. The ligands of the present disclosure may be anionic in character, and contain an anionic donor atom or an anionic donor group (for complexing lithium) whose pKₐ may have been modified to promote complexation of a lithium ion through displacement of one or more of the water ligands thereon. Modification of the pKₐ, described in further detail hereinafter, may further improve the energetic and enthalpic favorability of the ligand complexation and water ligand displacement from the lithium ion. As many as all four of the water ligands in the hydrated lithium ions may be displaced by the ligands described herein. Additional lone pair donors and/or additional groups to promote pKₐ matching may also be present in the ligands described herein, one or more of which may be complexed to the lithium ion in a lithium complex containing one or more anionic functional groups complexed thereto.

Accordingly, lithium complexes of the present disclosure may comprise a lithium ion, one or more ligands comprising at least one anionic functional group, and up to four water ligands coordinated to the lithium ion. The one or more ligands may be entropically configured to complex the lithium ion. The one or more ligands are described further hereinbelow. The one or more ligands and the water ligands (if remaining bound to lithium) may complex the lithium ion in a tetracoordinate geometry, wherein possible tetracoordinate geometries include tetrahedral, distorted tetrahedral, square planar, see-saw, or the like. The one or more ligands may be directly coordinated to the lithium ion through one, two, three, or four coordinate covalent bonds via the anionic functional group (i.e., the one or more ligands may bond in a monodentate, bidentate, tridentate, or tetradentate fashion depending on arrangement in the ligand) such that each coordinate covalent bond displaces a water ligand from the lithium ion. Alternately, the at least one ligand or a portion thereof may indirectly coordinate to the lithium ion through hydrogen bonding or another type of molecular association of the at least one anionic functional group with a water ligand. Combinations of direct and indirect complexation may be present in a given lithium complex in which only some of the water ligands are displaced. When the ligands of the present disclosure directly complex the lithium ion by forming at least one coordinate covalent bond, the number of water ligands displaced from the lithium ion may be equivalent to the number of coordinate covalent bonds formed by the at least one ligand. That is, the number of coordinate covalent bonds formed between the lithium ion and the at least one ligand may be one, two, three, or four, and the number of displaced water ligands may correspondingly be one, two, three, or four.

Ligands of the present disclosure may comprise at least one anionic functional group such as an arylboronic acid, a carboxylic acid, a sulfonic acid, a phosphonic acid, a phosphoramidic acid, or any combination thereof. Multiple anionic functional groups or combinations thereof may be present in a given ligand. Preferably, at least one arylboronic acid group is present, and in some cases at least two arylboronic acid groups are present. When multiple anionic functional groups are present, the ligands of the present disclosure may optionally complex a lithium ion in a multidentate fashion by displacing a corresponding number of water ligands or by associating with multiple water ligands. Depending on the number and orientation of the anionic functional groups, the ligands may be monodentate, bidentate, tridentate, or tetradentate. A neutral donor atom, such as an amine (a lone pair donor) within the ligands, may also be coordinated with the lithium ion in some instances.

Illustrative lithium complexes of the present disclosure may have a formula of LiL₄, LiL₃(H₂O), LiL₂(H₂O)₂, LiL(H₂O)₃, LiL(H₂O)₂, LiL₂(H₂O), LiL₂, LiL(H₂O), or LiL, depending on the denticity of the ligand, wherein L represents the ligand, and the corresponding number of water ligands displaced. Charges are not shown in the foregoing complex structures, but it is to be appreciated that the lithium complexes may be net positive, net neutral, or net negative depending on how many anionic functional groups are present in total.

In the case that the ligands associate with but do not displace the water ligands, the lithium complexes of the present disclosure may have a formula of Li(H₂O)₄Lₙ, wherein n is 1, 2, 3, or 4, depending upon the number of ligands that associate with the water ligands.

The ligands and lithium complexes of the present disclosure may provide ready means for chemically capturing lithium or sensing lithium in a range of media by controlling variables to achieve lithium complexation through thermodynamic and kinetic control resulting from ligand pre-organization. This development overcomes limitations in the art of lithium complexation and sequestration by addressing factors such as unfavorable phase behavior in organic solvents, slow kinetics of physical adsorption such as in synthetic zeolites, ready ability for mass production, and facile deployment to capture low lithium concentrations in complex fluids with mixed phases at high flow rates. The foregoing may be achieved in the present disclosure by recognizing a lithium ion as a charged hydrate, instead of a charged sphere. Thus, by incorporating features of pKₐ matching, proton ionizable group(s) (anionic functional groups), and lone pair donor(s) in the ligands described herein, the ligand sphere can satisfy the charge requirements for binding lithium. Groups providing pKₐ matching, proton ionization, and/or lone pair donation may be tethered together to define the ligand structure. Charge requirements for lithium ions may be met by providing the various groups in the ligand sphere to support the electronic geometry requirements with modes such as hydrogen bonding, charge transfer complexes, ion-pairing, coordinate covalent bonding and the like. Exemplary bonding modes for complexing a lithium ion include, but are not limited to, those shown in Scheme 1 below. The structures in Scheme 1 presume that at least some of the water ligands undergo displacement upon exposure to the ligand containing at least one anionic functional group.

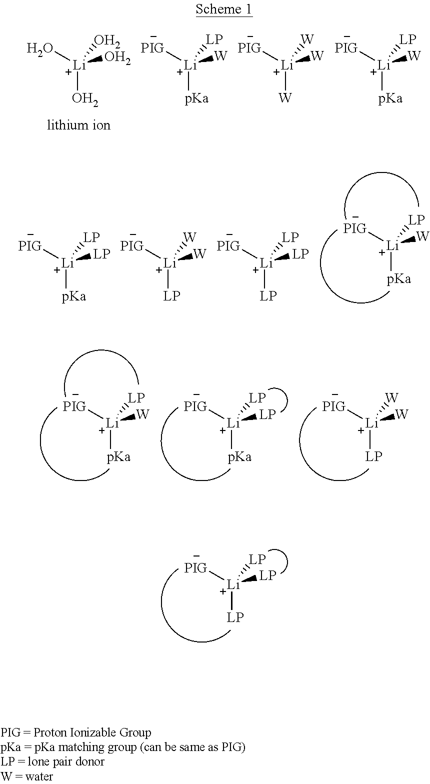

In some embodiments, the anionic functional group may be further complexed or stabilized internally via a heteroatom to change the pKₐ value thereof. The internal complexation may render the anionic functional group more electronically or geometrically capable of complexing a lithium ion. In the case of arylboronic acids, for example, the boron atom of the arylboronic acid may be internally complexed with a heteroatom (e.g., by lone pair donation to the unoccupied p-orbital of boron) to facilitate complexation of lithium at a near-neutral pH. Phosphonic acids and phosphoramidic acids, in contrast, may be more effective for lithium complexation at acidic pH values. Additional details regarding the internal complexation follow below.

While arylboronic acids may have a favorable binding site for complexing lithium ions through displacement of one or more of the complexed water ligands in hydrated lithium, it is through internal heteroatom complexation that binding of lithium ions may be more practically realized. Without being bound by theory or mechanism, internal heteroatom complexation of the boron atom in an arylboronic acid (i.e., donation of a lone pair of electrons from a nitrogen atom or an oxygen atom to an empty p-orbital upon the boron atom via a 5- or 6-membered ring complex) is believed to alter the pKₐ of the arylboronic acid, thereby increasing the affinity of the arylboronic acid toward binding a lithium ion through displacement of at least one water ligand. That is, the internal complexation is believed to activate the arylboronic acid toward lithium complexation in a near-neutral pH environment. Moreover, the favorable binding geometry of the ligands is believed to promote displacement of the coordinated water ligands in hydrated lithium ions via an entropically favorable reaction to facilitate direct lithium ion complexation in the disclosure herein, as also discussed hereinafter. The ligands are believed to provide a tetracoordinate binding geometry, possibly similar to that found in hydrated lithium ions, in accomplishing the foregoing. The example of an arylboronic acid having heteroatom complexation as an anionic functional group may facilitate lithium complexation in a pH range of about 5-8, preferably about 6-7.5. A phosphonic acid or phosphoramidic acid ligand may be employed for acidic pH values less than about 5. Any of these ligands may be utilized in free form or covalently bonded to a substrate or other suitable moiety, as discussed further herein.

As a further advantage, the ligands described herein may be readily associated with dyes and similar indicators that undergo a detectable change, such as a change in spectroscopic signature or electrochemical signature, in the presence of lithium ions. Thus, by associating a dye or indicator with the ligands described herein upon a substrate, optionally with the dye or indicator covalently bonded to the ligand or the substrate, the active portion of effective solid-phase sensors for lithium ions may be realized. The association between the ligands and the dye or indicator may be covalent or non-covalent in nature. Moreover, the dye or indicator may be covalently bonded to the substrate or non-covalently associated with the substrate separately from the ligand itself. That is, in some examples, the dye or indicator may be covalently bonded to a first portion of the substrate, and the ligand may be covalently bonded to a second portion of the substrate. Depending on application-specific needs, the substrate may comprise a thin-film surface or a substrate defined as a plurality of particulates, such as a thin-film polymer surface or polymer particulates (e.g., macroparticulates having at least one dimension larger than 1 mm in size), wherein the polymer may comprise a plurality of reactive groups, such as epoxides, for attaching the ligands to the substrate. For example, suitably functionalized ligands disclosed herein may be reacted with polyglycidyl (meth)acrylate or a copolymer thereof to form a functionalized substrate that may be capable of complexing lithium ions. Alternately, the ligands may be covalently bonded to a glycidyl (meth)acrylate monomer or another polymerizable group, which may then undergo polymerization to result in covalent bonding of the ligand to a polymer substrate. Such functionalized substrates (e.g., a multi-functionalized epoxide surface) may achieve a high density of ligands upon the surface for bonding of lithium ions thereto. The ligand may be already bound to the surface or contain a reactive functionality that is capable of reacting with the surface, such as an amine nucleophile or other nucleophile in the case of a surface containing a plurality of epoxides. By having a having a high density of reactive functionalities upon the surface, a corresponding high binding capacity for lithium ions may be realized after covalent bonding of the ligands to the surface has taken place. Thus, the present disclosure provides considerable flexibility in the manner in which lithium binding and detection may be realized.

Ligands of the present disclosure that are capable of binding lithium may include at least one arylboronic acid group that is internally complexed with a lone pair of electrons from a heteroatom, such as nitrogen or oxygen. In non-limiting examples, the lone pair of electrons may be donated from an amine, an ether, a sulfonyl group, or a carbonyl group that is suitably positioned to donate the lone pair of electrons to the boron atom of the arylboronic acid. Other nitrogen- or oxygen-containing functional groups may also be effective to promote internal complexation and activation of the at least one arylboronic acid. Internal complexation may occur via formation of a 5- or 6-membered ring, for example. Moreover, the ligands of the present disclosure may be immobilized upon a surface, such as a polymer surface or a particulate surface, through covalent bonding via a linker moiety, as discussed in more detail hereinafter. Alternately or additionally, the arylboronic acid ligands of the present disclosure may be covalently bonded to a dye or similar analytically detectable molecule, as discussed further herein. Optionally, the arylboronic acid ligands that are covalently bonded to a dye or similar analytically detectable molecule may be further covalently bonded to a surface (e.g., a macroparticulate surface or a thin-film surface), or the arylboronic acid ligands may be adsorbed to such surfaces to facilitate detection and/or extraction of lithium ions.

Accordingly, lithium complexes of the present disclosure may comprise a lithium ion, at least one ligand comprising at least one anionic functional group complexed to the lithium ion via a coordinate covalent bond, and up to four water ligands coordinated to the lithium ion. Preferably, the at least one anionic group is internally complexed with a heteroatom, such as an arylboronic acid group internally complexed with a heteroatom. Any of the ligands described herein may be effective for complexing lithium in this manner. Optionally, the ligands may be covalently bonded to a substrate, such as a polymer, a polymerizable group, a reactive group capable of functionalizing a polymer or other substrate, a particulate, a water-solubilizing group, a group having surfactancy, a dye, an indicator, or the like, including when complexed to a lithium ion. The ligands may provide a pre-organized, entropically favorable binding site for binding the lithium ion.

In some embodiments, the ligands may comprise an arylboronic group that is internally complexed with a first heteroatom. Such ligands may have a structure represented by Formula 1

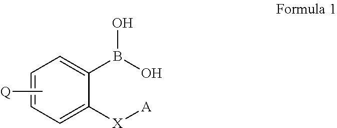

wherein X is a heteroatom-containing group capable of forming a 5- or 6-membered internal complex with boron, A is an optional linker moiety covalently bonded to at least a second anionic functional group, and Q is optional substitution upon the aromatic ring at any open valence position (0-4 Q substitutions may be present). In non-limiting examples, X may be —CH₂NR¹—, —CH₂CH₂NR¹—, —CH₂O—, —CH₂CH₂O—, —C(═O)—, —CH₂C(═O)—, —C(═O)O—, —CH₂CO(═O)O—, —C(═O)NR¹—, or —CH₂CO(═O)NR¹—, wherein R¹ is H or an alkyl group. Accordingly, Formulas 1A-1J below show some specific examples of ligands in which internal heteroatom complexation of boron may occur via formation of a 5- or 6-membered ring to promote subsequent complexation of lithium ions (the dashed bond represents the internal complexation occurring via a dative bond, in which a lone pair of electrons on the heteroatom is donated to an empty p-orbital upon boron). Formation of the 5- or 6-membered internal complex of boron may activate the arylboronic acid group toward complexation of lithium ions.

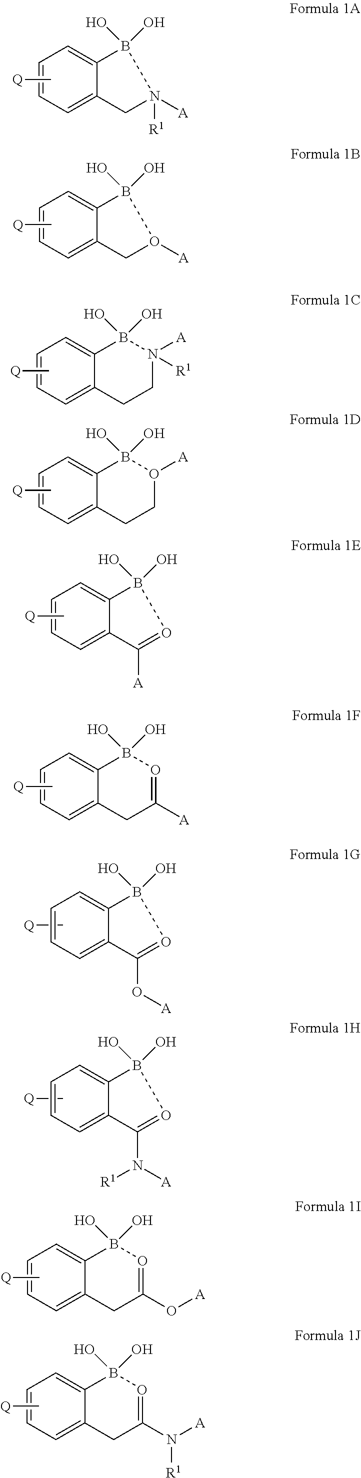

Particularly suitable examples in which internal complexation of boron may take place by formation of a 5- or 6-membered ring include the ligands having structures represented by Formula 1A-1D. Other suitable examples for X that may be capable of forming a 5- or 6-membered ring internal complex with boron include, for instance, —NR²C(═O)NR²—, —CH₂NR²C(═O)NR²—, —O(C═O)NR²—, —NR²C(═O)O—, —CH₂NR²C(═O)O—, —NR²S(═O)₂NR²—, —CH₂S(═O)₂NR²—, and S(═O)₂NR²—, wherein R² is H or an alkyl group.

In some embodiments, linker moiety A may be present and provide a tether to a second anionic functional group. Such ligands may have a structure represented by Formula 2

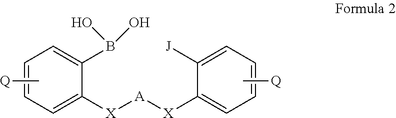

wherein J is an anionic group, such as B(OH)₂, CO₂H, SO₃H, PO₃H₂, SO₃H, or NHPO₃H₂ (protonated forms of anionic ligands shown) and the other variables are defined as above. When a second anionic group is present, the ligand may complex a lithium ion in a bidentate fashion to complete a tetracoordinate binding environment or in a monodentate fashion, optionally with up to four water ligands also being present. In the case where J is B(OH)₂, symmetrical or near-symmetrical ligands having a structure represented by Formula 3 may be obtained, wherein the variables are again defined as above. The second arylboronic acid in Formula 3 may be stabilized by internal heteroatom complexation in a similar manner to that discussed above.

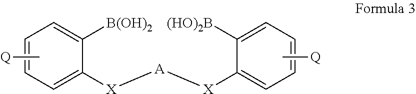

In some examples, linker moiety A is an optionally substituted hydrocarbyl group, such as

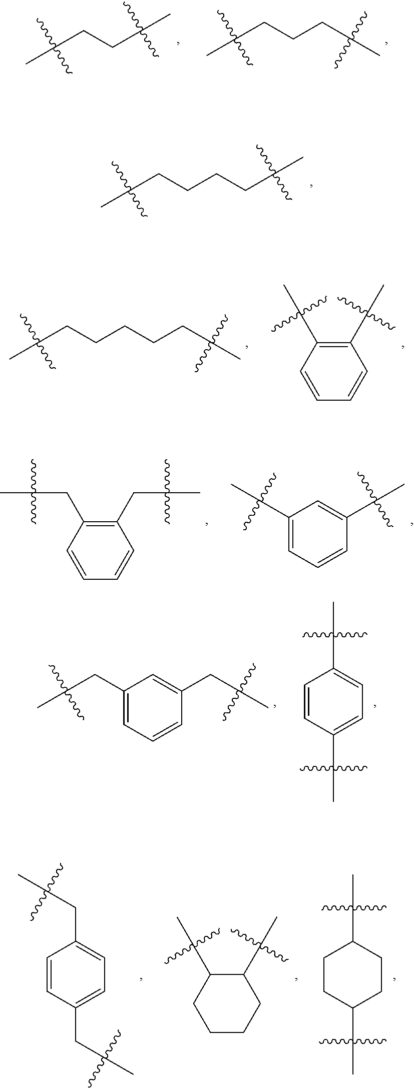

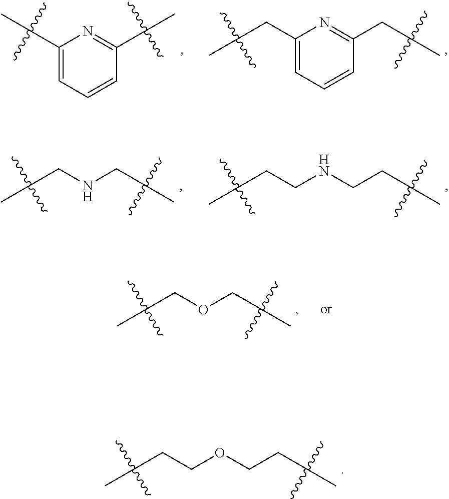 [SMILES: *c1cccc(*)n1 ; *Cc1cccc(C*)n1 ; *CNC* ; *CCNCC* ; *COC* ; *CCOCC*]

Selections for linker moiety A bearing an amine group may be readily functionalized to promote covalent bonding to a substrate, a dye, or an indicator as discussed hereinbelow. In addition, selections for linker moiety A that bear a heteroatom may also complex the heteroatom in the lithium complexes disclosed herein.

In more specific examples, the ligand may have a structure represented by one or more of Formulas 4A-4H,

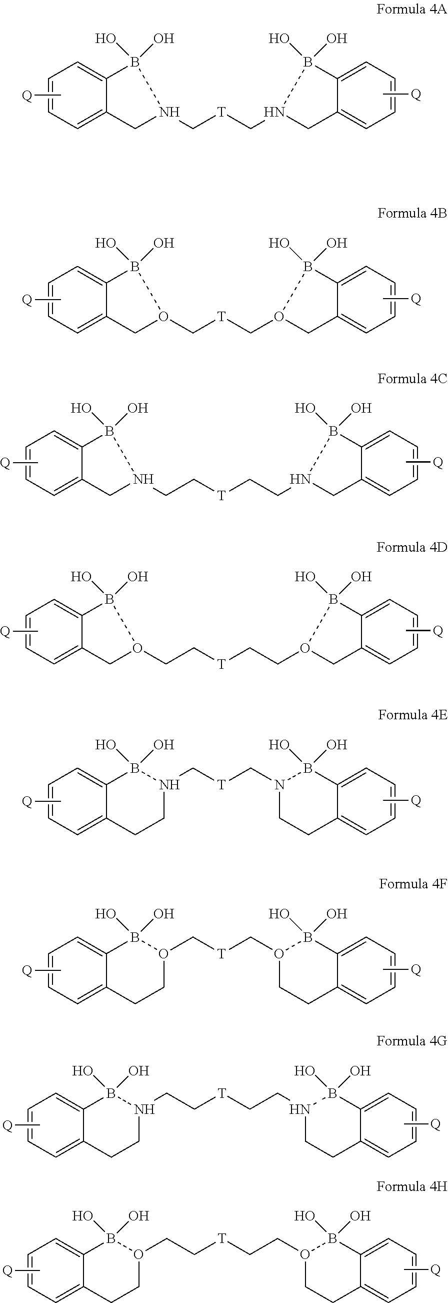

wherein T is CH₂, O, NH, CHNH₂, CHCH₂, or CHN₃. Any of the foregoing selections for T bearing a free amine may be further reacted with an electrophile, such as an epoxide group, to facilitate functionalization thereof, such as to promote covalent bonding to a substrate, a reactive functional group, a polymerizable group, a water-solubilizing group, a group having surfactancy, a dye, or an indicator, for example.

In non-limiting examples, an amine within T may be reacted with polyglycidyl (meth)acrylate or glycidyl (meth)acrylate monomer to promote epoxide opening and covalent bonding of the ligand to a polyglycidyl (meth)acrylate substrate or a precursor thereto. Optionally, the polyglycidyl (meth)acrylate or a copolymer thereof may be preformed into a macroparticulate, discussed further hereinbelow, prior to promoting epoxide opening and substrate bonding of the ligand. In still other examples, an amine within T may be covalently bonded to a reactive functional group capable of becoming covalently bonded to a substrate, a polymerizable group, a water-solubilizing group, a group having surfactancy, a dye, or an indicator.

In addition to the ligands comprising at least one arylboronic acid, suitable ligands may alternately include at least one phosphonic acid, phosphonamidic acid, or any combination thereof. Suitable examples of such ligands that may be present in lithium complexes may include, but are not limited to, ligands shown in Formulas 5A-5H below.

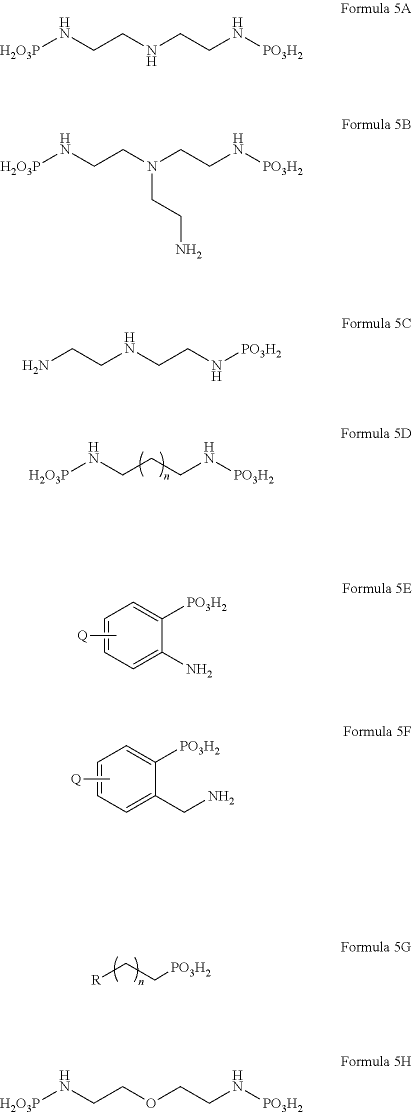

Phosphonic ester or phosphoramidic ester forms of any of the foregoing may also be suitable for complexing lithium ions in some cases. In the foregoing, Q is optional aromatic ring substitution, n is 1, 2, 3, or 4, and R is NH₂, OH, or a leaving group (e.g., chloride, bromide, iodide, or sulfonate ester). Nucleophilic nitrogen atoms may be covalently bonded to a substrate through a reaction with an electrophile. For example, a free amine in any of the foregoing may be reacted with an electrophile such as an epoxide group to promote covalent bonding to a substrate, such as polyglycidyl (meth)acrylate or a copolymer thereof or a precursor thereof in a suitable form.

As referenced in brief above, the foregoing ligands and/or the lithium complexes may be covalently bonded to a substrate, such as through nucleophilic opening of an epoxide in non-limiting examples. In non-limiting examples, covalent bonding of the ligands to the substrate may be facilitated through incorporation of a reactive group or a polymerizable group into linker moiety A. It is to be appreciated, however, that reactive or polymerizable groups may be incorporated elsewhere in the ligands, provided that doing so does not interfere with the complexation of lithium ions. The substrate may further facilitate complexation of lithium ions and further separation of the lithium ions from their source.

Ligands of the present disclosure featuring at least one arylboronic acid and that are covalently bonded to a substrate (alternately to a polymerizable group, a reactive functionality, a water-solubilizing group, a group having surfactancy, a dye, or an indicator) may have a structure represented by Formula 6,

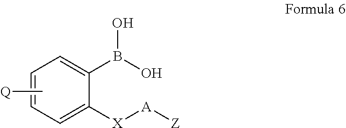

wherein Z is a substrate or a group capable of forming a covalent bond to a specified substrate, such as a reactive functionality that may undergo a reaction with a complementary functionality upon a substrate, a water-solubilizing group, a group having surfactancy, a dye, or an indicator. The other variables are defined as above. The substrate may be a surface, such as a polymer surface in some examples, with polyglycidyl (meth)acrylate or a copolymer thereof being a representative example of a suitable polymer. Other polymers may also be suitable in this regard. When Z is a dye or indicator, the dye or indicator may facilitate detection of when a lithium complex has formed.

Linker moiety A may be divalent or trivalent when the ligand is covalently bonded to a substrate or an alternative group mentioned above. If divalent, linker moiety A provides a direct tether between heteroatom-containing group X and substrate Z (or a functional group capable of forming a covalent bond to a specified surface, or a dye or indicator). If trivalent, linker moiety A may be further covalently bonded to a second anionic functional group capable of complexing a lithium ion. For example, when linker moiety A is trivalent, ligands having a structure represented by Formula 7 (a variant of the ligand having a structure represented by Formula 2) may be obtained, wherein the variables are further defined as above.

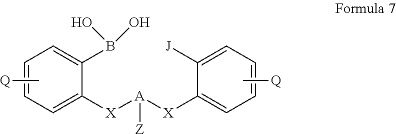

In the case where J is B(OH)₂, symmetrical or near-symmetrical ligands having structures represented by Formula 8A are obtained, wherein the variables are again defined as above.

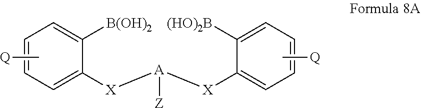

In Formulas 7 and 8A, linker moiety A may be any of the linker moieties specified above, provided that there is an available bonding site for forming a covalent bond to Z. Particularly suitable examples of linker moiety A for promoting covalent bond formation to a substrate may include, for example, an optionally substituted hydrocarbyl group, such as

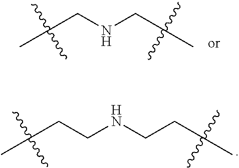 [SMILES: *CNC* ; *CCNCC*]

The amine group in linker moiety A may be directly reacted with a complementary functional group in the Z or may be further reacted with a group bearing a functional group capable of reacting with a complementary functional group in Z.

More specifically, in some examples, the ligand may have a structure represented by Formula 8B

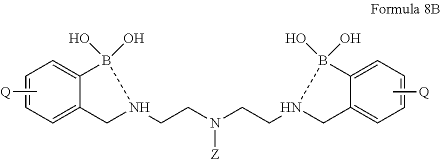

wherein Z is a substrate (e.g., a polymer), a polymer, a reactive functional group that may form a covalent bond with a complementary group upon a substrate, a water-solubilizing group, a group having surfactancy, a dye, or an indicator, and Q is optional aromatic ring substitution.

In the foregoing, variable Z may be a polymer or a polymerizable group; an amine directly bonded to or within linker moiety A or tethered to linker moiety A, or a reaction product thereof that bonds linker moiety A to a substrate; or an azide directly bonded to linker moiety A or tethered to linker moiety A, or a reaction product thereof that bonds linker moiety A to a substrate. Variable Z may define a substrate or a group capable of undergoing a reaction with a substrate. For example, an azide may undergo a “click” cycloaddition reaction with an alkyne partner to form a triazine. Alternately, variable Z may be a water-solubilizing group (e.g., a polyol or a polyether) or a group having surfactancy (e.g., an amphiphilic group having a hydrophilic head group and a hydrophobic tail or body, wherein the hydrophilic head group may be cationic, anionic, neutral, or zwitterionic in nature). Variable Z may also be a dye or indicator, or a molecule that is easily electrochemically detectable. In some embodiments, the polymer or polymerizable groups may include (meth)acrylate polymers or (meth)acrylate derivatives, for example, such as polyglycidyl (meth)acrylate or glycidyl (meth)acrylate. These groups may be readily form functionalized substrates in which the ligands may become covalently bonded to the substrate, as described in more detail hereinbelow. Alternately, variable Z may comprise a group, such as an amine, that may promote nucleophilic opening of epoxides to promote covalent bonding to a polymer surface. Thus, in any embodiment, the ligands of the present disclosure may be covalently bonded to a polymer via ring-opening of an epoxide group.

In more specific examples, the ligand may have a structure represented by one or more of Formulas 9A-9H, in which variable Z is directly or indirectly bonded to the linker moiety extending between the two arylboronic acids,

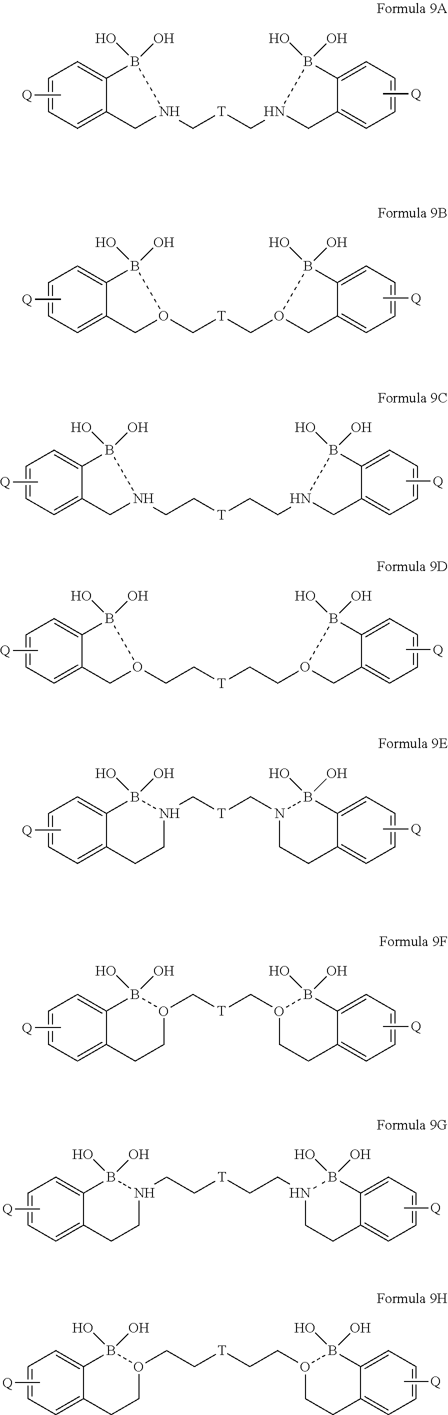

wherein T is CH—Z, N—Z, CH—NH—Z, CH—CH₂—Z, CH—NH—C(═O)—Z or CH—N₃ or a substrate-bound variant thereof. For example, Z may be a polymer or a polymerizable group, a reactive functional group, a water-solubilizing group, a group having surfactancy, a dye, or indicator.

In still more specific embodiments, the ligands of the present disclosure may have a structure represented by one or more of Formulas 10A-10D, wherein G is a second linker moiety and Z is defined as above.

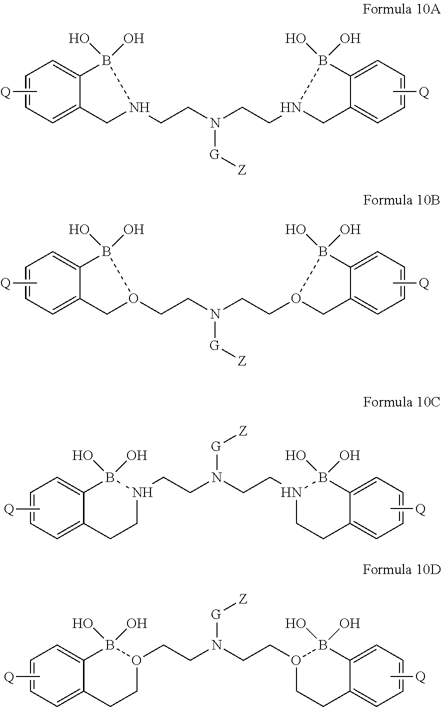

For example, G may be a hydrocarbyl group, such as CH₂ or (CH₂)ₙ.

In some alternative embodiments, the position of the second aryl boronic acid and variable Z may be reversed, such that the second arylboronic acid is directly bonded to a secondary amine, and variable Z is directly bonded to a primary amine. Such ligands may have a structure represented by Formula 11 below.

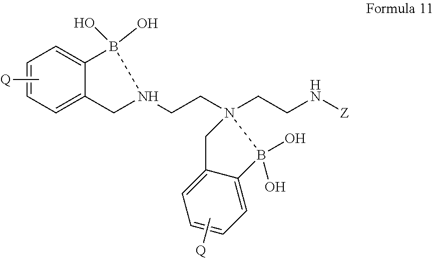

In still more specific examples, the ligand may have a structure represented by Formulas 12A-12D, or a polymerized reaction product form thereof.

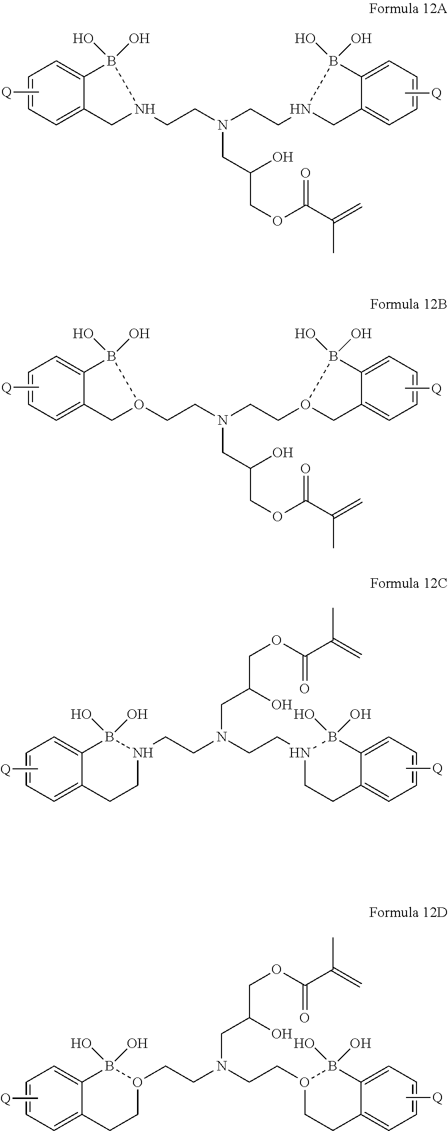

The dangling (meth)acrylate double bond may be copolymerized with another acrylate monomer, such as (meth)acrylamide, (meth)acrylic acid, or glycidyl (meth)acrylate to facilitate bonding of the ligand to a substrate. Alternately, the dangling (meth)acrylate double bond may be polymerized onto an existing poly(meth)acrylate polymer. Other types of ethylenically unsaturated co-monomers may also be present, as discussed elsewhere herein.

In some examples, the ligands may be bound to a substrate via a linker moiety that is a hexasubstituted benzene, such as those described in U.S. Pat. No. 11,267,773, which is incorporated herein by reference in its entirety. Suitably functionalized hexasubstituted benzenes may be readily bound to a surface with a controlled orientation, while leaving 1, 2, or 3 functionalities oriented opposite the surface to bind with an internally complexed arylboronic acid ligand of the present disclosure. Optionally, a dye or similar indicator and/or an internal buffer moiety may be covalently bonded to the hexasubstituted benzene on a face opposite the surface in some instances. Suitable surfaces for covalent bonding of the hexasubstituted benzenes thereto are wide-ranging and may include, for example, acrylics, other plastics, glass, metals, ceramic, cement, wood, geological materials, and the like. The surface may contain suitable functionality for undergoing a chemical reaction to form a covalent bond with a complementary functional group upon the hexasubstituted benzene. In non-limiting examples, a suitable surface may bear an alkene that may undergo a free radical reaction with an alkene group upon the hexasubstituted benzenes or an alkyne group that may undergo a cycloaddition reaction with an azide upon the hexasubstituted benzenes. In other examples, a surface may bear an electrophile for reaction with a benzylic amine in the hexasubstituted benzenes. For example, a surface may bear a plurality of epoxide groups, which may undergo ring opening and covalent bond formation upon contacting a benzylic amine upon the hexasubstituted benzenes. In all of these embodiments, the hexasubstituted benzene may serve as a linker moiety or a portion of a linker moiety covalently bonding the ligand to the surface.

Examples of hexasubstituted benzenes suitable for facilitating covalent bonding of internally complexed arylboronic acids to a surface may include a compound having a structure represented by Formula 13 below, wherein the benzylic azides may react with an alkyne-functionalized surface to form a 1,2,3-triazine linker to the surface (e.g., through a “click chemistry” cycloaddition reaction), or the benzylic azides may undergo reduction to provide benzylic amines for promoting internal complexation of the arylboronic acid ligand for activation thereof toward complexation of lithium ions, in which case the epoxides may undergo a nucleophilic ring-opening reaction to promote surface bonding. Alternately, a benzylic amine may be reacted with a complementary group upon a suitably functionalized surface, and the epoxides may promote bonding of the arylboronic acid ligand to the surface via a suitable linker moiety, such as a linker moiety containing a nitrogen nucleophile. In still another example, the epoxides may undergo nucleophilic opening with a suitable nucleophile (before or after introducing the benzylic azides), and the benzylic azides may be subsequently reduced to the corresponding benzylic amines. The benzylic amines, in turn, may be functionalized with a benzylic halide boronic acid or boronate ester or undergo reductive amination with a benzaldehyde boronic acid or boronate ester. The secondary hydroxyl group of the ring-opened epoxide or a functional group in the nucleophile that promoted epoxide ring opening may then be utilized to facilitate bonding to a surface. Such a functionalization approach is shown in Scheme 2 below (Nuc: is a nucleophile, and X is an electrophile).

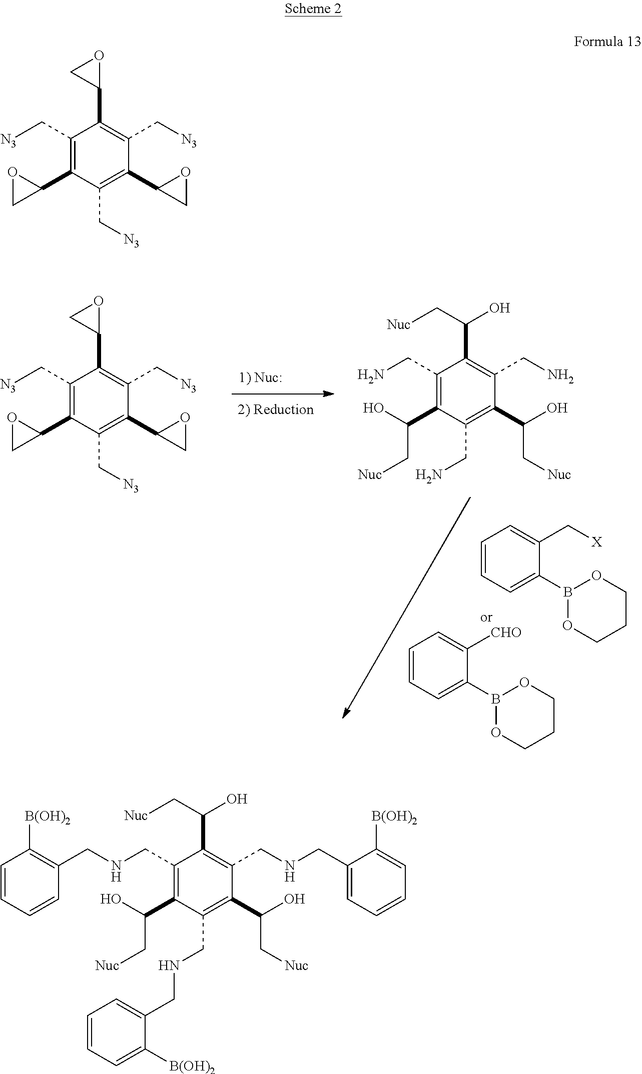

In some or other embodiments, the internally complexed arylboronic acid ligands may be covalently bonded to a polymer surface, such as a polymer surface comprising polyglycidyl (meth)acrylate or other polymer bearing a plurality of epoxide groups to promote surface attachment. In more specific examples, the polymer surface comprising polyglycidyl (meth)acrylate may define a macroparticulate, as described in more detail in U.S. Patent Application Publication 2022/0259351, which is incorporated herein by reference in its entirety. Macroparticulates comprising polyglycidyl (meth)acrylate may be desirable, since a plurality of arylboronic acid ligands may be disposed upon the surface of a single macroparticulate by reacting the plurality of side chain epoxides thereon. Moreover, macroparticulates are easily handled and separated from an aqueous fluid to allow recovery of lithium ions therefrom. The term “polyglycidyl (meth)acrylate” refers to an olefinically polymerized monomer having a side chain epoxide linked to the main polymer backbone by a methylene group and a heteroatom. The term “meth” in parentheses means that a methyl group may or may not be present upon the polymer backbone. If a methyl group is absent, a hydrogen is present in its place. In the disclosure herein, the term “polyglycidyl (meth)acrylate” refers equivalently to (meth)acrylate esters and (meth)acrylamides. The term “macroparticulate” refers to any particulate material having an average size of about 1 mm or more, or about 5 mm or more, or about 10 mm or more in size.

More specifically, polyglycidyl (meth)acrylates that may be present in macroparticulates according to the present disclosure may include monomer structures represented by Formulas 14 and 15, wherein variable R is H or a methyl group in both instances.

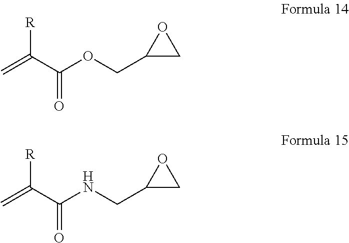

Optionally, other olefinically unsaturated monomers may also be copolymerized with the above monomers, including other (meth)acrylic monomers not bearing an epoxide group. Other monomers that may be copolymerized with the above olefinically unsaturated monomers include, for example, (meth)acrylic acid, (meth)acrylate esters, (meth)acrylamide, alpha olefins, olefins capable of forming crosslinks between adjacent polymer chains in individual macroparticulates, and the like. Methyl methacrylate and hydroxyethyl methacrylate may be particularly suitable olefinically unsaturated monomers that may be copolymerized with the above olefinically unsaturated monomers. Suitable alpha olefins that may be copolymerized with the above olefinically unsaturated monomers include, for example, ethylene, propylene, butene, pentene, hexene, heptene, octene, nonene, decene, undecene, dodecene or mixtures thereof. Diene monomers, such as dicyclopentadiene, butadiene, norbornadiene, and similar monomers, may also be copolymerized with any of the foregoing olefinically unsaturated monomers. Still other monomers that may be copolymerized with glycidyl (meth)acrylate include, for example, 2-hydroxyethyl methacrylate (HEMA), 3-(trimethoxysilyl)propyl methacrylate (TSPMA), poly(ethylene glycol) dimethacrylate (poly-EGMA), di-(ethylene glycol) dimethacrylate, tri-(ethylene glycol) dimethacrylate, 2-acetoacetoxyethyl methacrylate (AAEMA), methyl methacrylate, and zinc methacrylate. Illustrative glycidyl methacrylate (GMA) copolymers that may be formed under similar polymerization conditions include, for example, GMA-HEMA, GMA-TSPMA, GMA-poly-EGMA, GMA-AAEMA, GMA-ASEMA-HEMA, and GMA-AAEMA-TSPMA. Some of these GMA copolymers are configured to undergo crosslinking during and/or after polymerization, through reaction of their side chains or by incorporating a dangling olefinic unsaturation from a first polymer chain into a second polymer chain as the second polymer chain forms, thereby introducing crosslinks into the polymer. Any of these (meth)acrylic copolymers may undergo reaction with a nitrogen nucleophile having an internally complexed arylboronic acid appended thereto to form macroparticulates capable of sequestering lithium ions according to the disclosure herein.

Formula 16 represents a polyglycidyl (meth)acrylate polymer functionalized with a plurality of the ligands of the present disclosure through opening of side chain epoxide groups to promote surface bonding of the ligand. The structure represented by Formula 16 is the polymerized version of the structure represented by Formula 12A, wherein x, v, and z are unspecified positive integers (dative bonds not shown in Formula 16). The functionalized polyglycidyl (meth)acrylate polymer may comprise a plurality of ring-opened epoxide side chains and a plurality of side chain epoxides that are unopened. The distribution of ring-opened and unopened epoxide side chains may occur in any order.

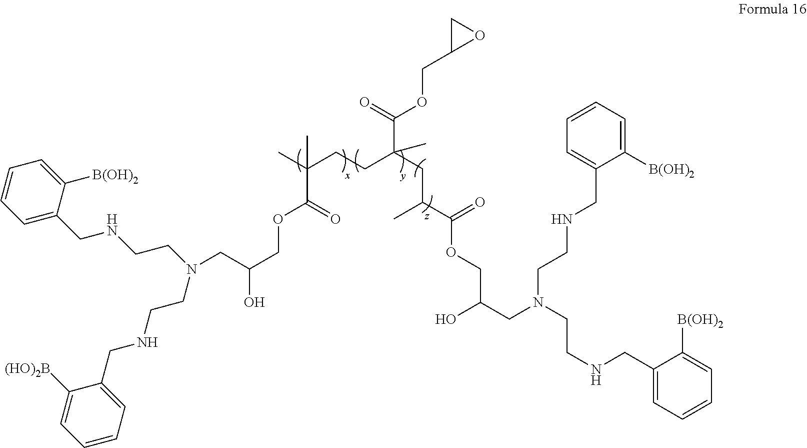

Glycidyl methacrylate may be polymerized or copolymerized and rendered into a form suitable for undergoing further functionalization with an internally complexed arylboronic acid or similar ligand of the present disclosure to form a macroparticulate. In particular, glycidyl methacrylate may be polymerized or copolymerized to a first polymerization state (e.g., through a living polymerization reaction or a free radical polymerization reaction) comprising a solid polymer product that may be isolated and rendered into a predetermined shape suitable for undergoing further functionalization with a nitrogen nucleophile having an internally complexed arylboronic acid appended thereto. Other polymerization techniques may also be suitable to achieve the first polymerization state. For example, a (meth)acrylate compound having a structure represented by Formula 12A may be copolymerized with glycidyl (meth)acrylate to form the copolymer directly rather than ring opening polyglycidyl (meth)acrylate with a nitrogen nucleophile bound to a ligand. The solid polymer product obtained in the first polymerization state may be crosslinked during the living polymerization reaction, or the polymer may be further crosslinked with a crosslinking agent thereafter, such as during functionalization with the nitrogen nucleophile or after functionalization with the nitrogen nucleophile has taken place.

Free radical polymerization, solution polymerization, suspension polymerization, or emulsion polymerization may also be suitable for forming the polymers and copolymers disclosed herein.

The polymer isolated in the first polymerization state may be rendered into the form of a dense body having a predetermined shape, such as a disk, sphere, extrudate, or similar structure. The structure obtained after rendering the polymer into a desired shape in the first polymerization state is solid, although some minor voids may be present depending on manufacturing or processing inconsistencies. The density obtained after rendering the polymer into the predetermined shape may represent that of the as-obtained polymer from the polymerization reaction. Advantageously, the predetermined shape provided at this juncture may be varied according to application-specific needs, such that a range of macroparticulate structures of any desired size or shape may be produced once further functionalization with a nitrogen nucleophile has taken place. As discussed further hereinbelow, the density of the predetermined shape may be decreased after functionalization with a nitrogen nucleophile has taken place to define a macroparticulate of the present disclosure.

Advantageously, a profile of the predetermined shape rendered at the pre-functionalization stage may be largely maintained following functionalization with a nitrogen nucleophile, except for undergoing volume expansion and a corresponding decrease in the density. That is, functionalization may promote an increase in size and/or other morphological changes of the pre-functionalization shape to afford the increased size and decreased density, while still maintaining the overall appearance of the predetermined shape following functionalization. Advantageously, spherical pre-functionalization shapes may maintain this shape following functionalization with a nitrogen nucleophile, particularly with an internal cavity being formed during functionalization. Other shapes may assume a more random (irregular) structure following functionalization of the polymer or copolymer with the nitrogen nucleophile. Spherical pre-functionalization shapes may be formed by rolling the (meth)acrylic polymer or copolymer in the first polymerization state into a substantially spherical shape before undergoing further functionalization with a nitrogen nucleophile bearing an internally complexed arylboronic acid. Without being held to any particular theory, the volume expansion occurring during functionalization is believed to originate from trapped molecules escaping as vapor during a heating cycle of the functionalization reaction, thereby forming an internal cavity in the reaction product. The internal cavity tends to be spherical or substantially spherical and differs from minor voids present in the pre-functionalization shape. As discussed below, the shape that is obtained following functionalization (both spherical and non-spherical shapes) may exhibit significant and advantageous morphological differences from the pre-functionalization shape, specifically due to formation of the internal cavity under suitable reaction conditions.

Volume expansion of the pre-functionalization shape and/or cavity formation within the pre-functionalization shape may be promoted by a suitable base when reacting with the nitrogen nucleophile. Suitable bases for forming macroparticulates comprising maintaining a profile from a predetermined shape but having an expanded volume and decreased density may include a tertiary amine base, such as trimethylamine, triethylamine, N,N-diisopropylethylamine (Hünig's base), 2,2,6,6-tetramethylpiperidine, 1,8-diazabicyclo[5.4.0]undec-7-ene (DBU), 1,5-diazabicyclo[4.3.0]non-5-ene (DBN), 4-dimethylaminopyridine (DMAP), and the like. Other mild Lewis bases may also be suitable. Unlike hindered, non-nucleophilic amine bases, inorganic hard bases, such as sodium hydroxide, do not lead to shapes having an expanded volume or formation of an internal cavity. Functionalization conducted in the absence of the base may lead to collapse of the pre-functionalization shape, rather than retention of the shape profile to afford a shape having an increased volume and/or decreased density. The extent of the volume expansion and the size of the internal cavity that results upon functionalization may vary depending upon the base used and the temperature at which the functionalization reaction is conducted. Thus, the combination of a nitrogen nucleophile and a suitable base may afford the surprising result of forming expanded macroparticulates having an internal cavity.

Macroparticulates or other polymeric forms (e.g., thin-films) prepared by opening epoxide groups within a polyglycidyl (meth)acrylate polymer or copolymer with an internally complexed arylboronic acid further tethered to an amine nucleophile may have a structure represented by Formula 17 below

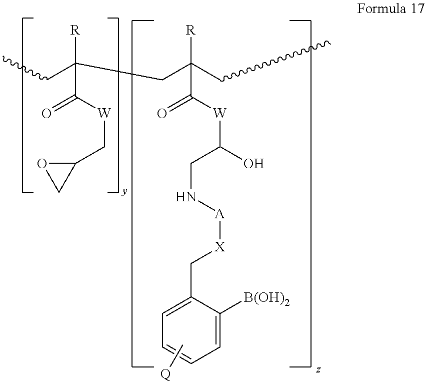

wherein W is O or NH, y and z are non-zero integers, and the other variables are defined as above. Variable y represents the mole fraction of glycidyl (meth)acrylate monomers and variable z represents the mole fraction of functionalized glycidyl (meth)acrylate monomers. The mole fraction of functionalized glycidyl (meth)acrylate monomers may range from about 1 mol. % to about 99 mol. %, or about 10 mol. % to about 90 mol. %, or about 20 mol. % to about 50 mol. %. The structure represented by Formula 16 is a particular example of the polyglycidyl (meth)acrylate polymer or copolymer having the structure represented by Formula 17.

The macroparticulates (or thin-films) of the present disclosure may further comprise a dye or similar tag adsorbed to a surface thereof for aiding analyses in which the macroparticulates (or thin-films) are used. For example, a dye or similar tag may change colors when lithium ions are bound by the arylboronic acid, thereby providing an indication of the amount of lithium that has become bound and/or when the macroparticulates have become saturated with complexed lithium. Advantageously, dyes and similar tags may be adsorbed onto the macroparticulates without having to perform an additional functionalization reaction. Electrochemically active molecules may be used similarly in this regard. Without being bound by any theory or mechanism, the adsorption of dyes onto the surface of the macroparticulates is believed to result from complementary hydrophobic interactions between dye molecules and the hydrophobic polymer backbone. However, dyes with a similar surface energy may bind to macroparticulates with similar functionality. Nonpolar dyes may bind to macroparticulates that are more hydrophobic in nature, and charged dyes may bind to macroparticulates having charged groups. Suitable dyes may be chosen such that when they interact with a particular analyte of interest, a change in absorbance, fluorescence or luminescence occurs, typically in the wavelength of about 400 nm to about 700 nm.

In alternative embodiments, dyes or similar tags may be covalently bonded to the surface of the macroparticulates in combination with the internally complexed arylboronic acids. In still another example, a dye, indicator, or similar tag may be covalently bonded to a ligand, as discussed further above.

The dye or similar tag may comprise alizarin, in some embodiments. Other dyes or similar tags may include, for example, alizarin red S, alizarin complexone, malachite green, brilliant green, crystal violet, erythrosin B, methyl green, methyl violet, picric acid, naphthol yellow S, quinaldine red, eosin Y, metanil yellow, m-cresol purple, thymol blue, xylenol blue, basic fuchsin, eosin B, cresol red, martius yellow, phloxine B, methyl yellow, bromophenol blue, congo red, methyl orange, bromochlorophenol blue WS, ethyl orange, fluorescein WS, bromocresol green, chysoidin, methyl red, alizarin red, cochineal, chlorophenol red, bromocresol purple, 4-nitrophenol, alizarin, nitrazine yellow, bromothymol blue, brilliant yellow, neutral red, rosolic acid, phenol red, 3-nitrophenol, orange II, phenolphthalein, o-cresolphthalein, Nile blue A, thymolphthalein, aniline blue WS, alizarin yellow GG, mordant orange I, tropaelin O, orange G, acid fuchsin, thiazol yellow G, gallocyanine, indigo carmine, carminic acid, celestine blue, and the like. Dyes and similar compounds bearing a catechol functionality may be especially advantageous for sensing lithium in combination with ligands containing at least one boronic acid, as in the disclosure herein.

In still other examples, dyes or similar tags, including the foregoing dyes and tags, may be covalently bonded to the ligand containing a stabilized arylboronic acid group.

Accordingly, the present disclosure may provide for detecting and/or determining an amount of lithium ions in a fluid, such as an aqueous fluid. Such methods may comprise: providing one or more ligands of the present disclosure, exposing the one or more ligands to a fluid comprising lithium ions; forming a complex of the one or more ligands with the lithium ions; and determining an amount of lithium ions present in the fluid based upon a spectroscopic change or electrochemical change of the one or more ligands in the presence of the lithium ions.

Although the foregoing polyglycidyl (meth)acrylate polymers and copolymers may be particularly advantageous in macroparticulate form, it is to be appreciated that such polymers may similarly be disposed in a thin-film form as well to realize similar advantages. Suitable thin-film forms may be disposed upon a substrate, wherein the ligand capable of complexing lithium ions may be introduced to the polymer before disposing the polymer upon the surface, or polyglycidyl (meth)acrylate may be reacted with a suitable ligand after deposition as a thin-film. Such surface-disposed thin-films may comprise at least a portion of a sensor capable of detecting lithium ions.

In still other embodiments, the internally complexed arylboronic acid ligands of the present disclosure may be covalently bonded to a molecule that undergoes an analytically detectable change when the one or more of the ligands are complexed with lithium ions, such as a dye or similar tag. In non-limiting examples, the analytically detectable change may comprise a spectroscopic change, an electrochemical change, or any combination thereof. Optionally, such ligands may be disposed upon a surface (either adsorbed or covalently bonded to the surface), wherein the ligands may define at least a portion of the active element of a sensor. Alternately, the ligands that are covalently bonded to a dye or similar tag may be utilized to promote detection and analysis of lithium ions in an aqueous fluid or a complex fluid comprising water and organic compounds.

Any of the dyes or similar spectroscopic tags described above may be covalently bonded to the ligands of the present disclosure via a linker moiety therein. Alternately, the dyes or similar spectroscopic tags may be utilized in combination with the ligands of the present disclosure without being covalently bonded thereto. Based on the change in spectroscopic signature produced by the dye or similar spectroscopic tag in the presence of bound lithium ions, the amount of lithium in a fluid may be determined (e.g., based on a calibration curve or similar analytical method).

Like the surface-bound or surface-bondable ligands discussed above, the foregoing dye-bound ligands may be incorporated upon a macroparticulate or thin-film polymer in the present disclosure. The dye-bound ligands may be absorbed or adsorbed to the polymer or may be covalently bonded if suitably functionalized. Thin-film polymers containing the ligands of the present disclosure may be deposited upon optically transparent substrates such as glass or polymers to facilitate direct detection of lithium ions by optical spectroscopy.

The surface-bound or surface-bondable ligands of the present disclosure may be utilized to promote extraction of lithium ions from aqueous or partially aqueous fluids (e.g., complex fluids containing water and organic solvents, optionally in emulsified form). Such methods may comprise providing one or more ligands of the present disclosure, exposing the one or more ligands to a fluid comprising lithium ions, forming a complex of the one or more ligands with the lithium ions, and removing the lithium ions from the fluid as a lithium complex of the ligand. Preferably, the one or more ligands are bonded to a surface when performing the foregoing.

When the ligand is bound to a macroparticulate, removing the lithium complex from the fluid may simply comprise flowing the fluid through a cartridge or bed of the macroparticulates, such that the fluid contains less lithium ions downstream from the cartridge or bed. Alternately, the macroparticulates, when not in a cartridge or bed, may be filtered or decanted from the fluid to affect removal of lithium ions therefrom.

When desired, the lithium ions may be recovered from the ligand. Recovery of the lithium ions may comprise decomplexing the lithium ions from the ligand, such as through heating, acid treatment, solvent addition, surfactant addition, or any combination thereof. Optionally, the lithium ions decomplexed from the ligand may be further purified or refined prior to further use thereof. After decomplexation of the lithium ions, the ligands may be reused if desired.

Continuous sequestration and analysis procedures utilizing the ligands (or macroparticulates or thin-films) of the present disclosure may be facilitated through use of a bed or cartridge of containing the ligands adsorbed or covalently bonded to a surface, such as macroparticulates or a polymer thin-film. Cartridges may come in many forms and include any structure capable of containing the macroparticulates, thin-film, or similar surface over a time during which the ligands are in contact with the fluid. As non-limiting examples, cartridges may be made of a rigid material, such as plastic, that is machined or molded to allow fluid access to the interior of the cartridge, or paper or cloth socks, bags, or the like may be used to contain the macroparticulates or a similar surface containing a covalently bonded ligand or adsorbed ligand. Cartridges of any type may be refillable or disposable. A fluid may be flowed through the bed or cartridge(s) containing the surface-bound ligand multiple times until a desired extent of lithium extraction or detection has been reached, or a single pass may be sufficient in some cases. Although such flow-through processes may be advantageous, particularly for remediating or analyzing large volumes of a fluid source, it is to be appreciated that the separation principles described herein may be applicable to batch-type processes as well. Thin-films containing the ligands may be used in a similar manner as well.

Embodiments disclosed herein include:

Embodiment 1. A lithium complex comprising:
a lithium ion;
one or more first ligands comprising at least one anionic functional group and entropically configured to complex the lithium ion; and
optionally, up to four water ligands coordinated to the lithium ion:
   wherein the one or more first ligands are directly coordinated to the lithium ion through one, two, three, or four coordinate covalent bonds via the at least one anionic functional group, each coordinate covalent bond displacing a water ligand from the lithium ion; the at least one first ligand is indirectly coordinated to the lithium ion through hydrogen bonding of the at least one anionic functional group with a water ligand; or any combination thereof; and
wherein the one or more first ligands and the water ligands complex the lithium ion in a tetracoordinate geometry.

Embodiment 1′: A lithium complex having a structure represented by one or more of Formulas 1, 1A-1J, 2, 3, 4A-4H, 5A-5F, 6, 7, 8, 9A-9H, 10A-10D, 11, 12A-12D, or 16.

Embodiment 2. The lithium complex of Embodiment 1 or Embodiment 1′, wherein the at least one first ligand is directly complexed to the lithium ion via the at least one anionic functional group, and a number of water ligands displaced from the lithium ion is equivalent to a number of coordinate covalent bonds made by the at least one first ligand.

Embodiment 3. The lithium complex of Embodiment 1, or Embodiment 1′, or

Embodiment 2, wherein the at least one anionic functional group comprises a moiety selected from the group consisting of an arylboronic acid, a carboxylic acid, a sulfonic acid, a phosphonic acid, a phosphoramidic acid, and any combination thereof.

Embodiment 4. The lithium complex of any one of Embodiments 1-3 or Embodiment 1, wherein the tetracoordinate geometry is tetrahedral or distorted tetrahedral.

Embodiment 5. The lithium complex of any one of Embodiments 1-3 or Embodiment 1′, wherein the tetracoordinate geometry is see-saw or square planar.

Embodiment 6. The lithium complex of any one of Embodiments 1-5 or Embodiment 1, wherein the one or more first ligands are covalently bonded to a substrate.

Embodiment 7. The lithium complex of Embodiment 6, wherein the substrate is a polymer, a dye, an indicator, or any combination thereof.

Embodiment 8. The lithium complex of any one of Embodiments 1-7 or Embodiment 1′, wherein the at least one anionic function group comprises at least one arylboronic acid.

Embodiment 9. The lithium complex of Embodiment 8, wherein the ligand comprises a first arylboronic acid and a second arylboronic acid, each internally complexed by a heteroatom.

Embodiment 10. A ligand comprising:
at least one arylboronic acid internally complexed with a first heteroatom:
   wherein the arylboronic acid is covalently bonded to a substrate via a linker moiety or the linker moiety contains a reactive functionality capable of forming a covalent bond to a substrate.

Embodiment 10′: A ligand having a structure represented by one or more of Formulas 1, 1A-1J, 2, 3, 4A-4H, 5A-5F, 6, 7, 8, 9A-9H, 10A-10D, 11, 12A-12D, or 16.

Embodiment 11. The ligand of Embodiment 10 or Embodiment 10′, wherein the at least one arylboronic acid is also covalently bonded to an anionic functional group via the linker moiety.

Embodiment 12. The ligand of Embodiment 11, wherein the at least one anionic functional group comprises an arylboronic acid, a carboxylic acid, a phosphonic acid, a phosphoramidic acid, or a sulfonic acid.

Embodiment 13. The ligand of Embodiment 11, wherein the at least one arylboronic acid comprises a first arylboronic acid and the anionic functional group comprises a second arylboronic acid, the second arylboronic acid being internally complexed with a second heteroatom.

Embodiment 14. The ligand of Embodiment 13, wherein the second heteroatom comprises nitrogen or oxygen.

Embodiment 15. The ligand of Embodiment 14, wherein the second arylboronic acid is internally complexed by an amine.

Embodiment 16. The ligand of Embodiment 15, wherein the first arylboronic acid is internally complexed by an amine different than the amine internally complexing the second arylboronic acid.

Embodiment 17. The ligand of Embodiment 10 or Embodiment 10′, wherein the first heteroatom comprises nitrogen or oxygen.

Embodiment 18. The ligand of Embodiment 17, wherein the at least one arylboronic acid is internally complexed by an amine.

Embodiment 19. The ligand of any one of Embodiments 10-18 or Embodiment 10′, wherein the substrate comprises a polymer, undergoes a spectroscopic change or electrochemical change in the presence of lithium ions, a dye, an indicator, or any combination thereof.

Embodiment 20. The ligand of Embodiment 19, wherein the polymer comprises polyglycidyl (meth)acrylate or a copolymer thereof.

Embodiment 21. The ligand of Embodiment 19 or Embodiment 20, wherein the polymer defines a plurality of macroparticulates.

Embodiment 22. The ligand of Embodiment 19 or Embodiment 20, wherein the polymer surface defines a thin-film.

Embodiment 23. The ligand of Embodiment 22, wherein the thin-film is deposited upon a support.

Embodiment 24. A lithium complex comprising a lithium ion, at least one ligand of any one of Embodiments 10-23 complexed with the lithium ion, and up to four water ligands complexed with the lithium ion.

Embodiment 24′. A lithium complex comprising a lithium ion, at least one ligand having a structure represented by one or more of Formulas 1, 1A-1J, 2, 3, 4A-4H, 5A-5F, 6, 7, 8, 9A-9H, 10A-10D, 11, 12A-12D, or 16, and up to four water ligands complexed with the lithium ion.

Embodiment 25. A sensor comprising the ligand of any one of Embodiments 10-23 or the lithium complex of Embodiment 24 or Embodiment 24′.

Embodiment 26. A method comprising:
providing the ligand of any one of Embodiments 1-23:
exposing the ligand to a fluid comprising lithium ions; and
determining an amount of lithium ions present in the fluid based upon a spectroscopic change or electrochemical change of the ligand in the presence of the lithium ions.

Embodiment 26′. A method comprising:
providing at least one ligand having a structure represented by one or more of Formulas 1, 1A-1J, 2, 3, 4A-4H, 5A-5F, 6, 7, 8, 9A-9H, 10A-10D, 11, 12A-12D, or 16;
exposing the ligand to a fluid comprising lithium ions; and
determining an amount of lithium ions present in the fluid based upon a spectroscopic change or electrochemical change of the ligand in the presence of the lithium ions.

Embodiment 27. The method of Embodiment 26 or Embodiment 26′, wherein the fluid comprises an aqueous fluid.

Embodiment 28. A method comprising:
providing the ligand of any one of Embodiments 1-23;
exposing the ligand to a fluid comprising lithium ions; and
removing the lithium ions from the fluid as a lithium complex of the ligand.

Embodiment 28′. A method comprising:
providing at least one ligand having a structure represented by one or more of Formulas 1, 1A-1J, 2, 3, 4A-4H, 5A-5F, 6, 7, 8, 9A-9H, 10A-10D, 11, 12A-12D, or 16;
exposing the ligand to a fluid comprising lithium ions; and
removing the lithium ions from the fluid as a lithium complex of the ligand.

Embodiment 29. The method of Embodiment 28 or Embodiment 28′, further comprising:
decomplexing the lithium ions from the ligand; and
optionally, further refining the lithium ions.

Embodiment 30. The method of Embodiment 29, wherein decomplexing comprises heating the ligand, exposing the ligand to an acid, or any combination thereof.

Embodiment 31. The method of any one of Embodiments 28-30 or Embodiment 28′, wherein the fluid comprises an aqueous fluid.

Embodiment 32. The method of any one of Embodiments 28-31 or Embodiment 28′, wherein the lithium ions are hydrated lithium ions. Embodiment TA. A lithium complex comprising:
a lithium ion:
one or more ligands comprising at least one anionic functional group and entropically configured to complex the lithium ion; and
up to four water ligands coordinated to the lithium ion;
   wherein the one or more ligands are directly coordinated to the lithium ion through one, two, three, or four coordinate covalent bonds via the at least one anionic functional group, each coordinate covalent bond displacing a water ligand from the lithium ion; the one or more ligands are indirectly coordinated to the lithium ion through hydrogen bonding of the at least one anionic functional group with a water ligand; or any combination thereof; and
wherein the one or more ligands and the water ligands complex the lithium ion in a tetracoordinate geometry.

Embodiment 2A. The lithium complex of Embodiment 1A, wherein the one or more ligands comprise a first anionic functional group that is an arylboronic acid internally complexed with a heteroatom.

Embodiment 3A. The lithium complex of Embodiment 2A, wherein the one or more ligands have a structure represented by

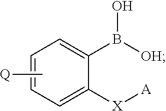

wherein Q is optional aromatic ring substitution, A is an optional linker moiety covalently bonded to at least a second anionic functional group, and X is —CH₂NR¹—, —CH₂CH₂NR¹—, —CH₂O—, —CH₂CH₂O—, —C(═O)—, —CH₂C(═O)—, —C(═O)O—, —CH₂CO(═O)O—, —C(═O)NR¹—, —CH₂CO(═O)NR¹—, —NR²C(═O)NR²—, —CH₂NR²C(═O)NR²—, —O(C═O)NR²—, —NR²C(═O)O—, —CH₂NR²C(═O)O—, —NR²S(═O)₂NR²—, —CH₂S(═O)₂NR²—, or S(═O)₂NR²—;
   wherein R¹ and R² are independently H or an alkyl group.

Embodiment 4A. The lithium complex of Embodiment 3A, wherein the linker moiety is present and is further covalently bonded to a substrate, a polymerizable group, a reactive functional group capable of forming a covalent bond to a substrate, a water-solubilizing group, a group having surfactancy, a dye, or an indicator.

Embodiment 5A. The lithium complex of Embodiment 3A, wherein the linker moiety is present and the second anionic functional group is a second arylboronic acid internally complexed with a second heteroatom.

Embodiment 6A. The lithium complex of any one of Embodiments 1A-5A, wherein the at least one ligand is directly complexed to the lithium ion via the at least one anionic functional group, and a number of water ligands displaced from the lithium ion is equivalent to a number of coordinate covalent bonds made by the at least one ligand.

Embodiment 7A. The lithium complex of any one of Embodiments 1A-5A, wherein the at least one anionic functional group comprises a moiety selected from the group consisting of an arylboronic acid, a carboxylic acid, a sulfonic acid, a phosphonic acid, a phosphoramidic acid, and any combination thereof.

Embodiment 8A. The lithium complex of any one of Embodiments 1A-5A, wherein the tetracoordinate geometry is tetrahedral or distorted tetrahedral.

Embodiment 9A. The lithium complex of any one of Embodiments 1A-5A, wherein the tetracoordinate geometry is see-saw or square planar.

Embodiment 10A. The lithium complex of any one of Embodiments 1A-5A, wherein the one or more ligands are covalently bonded to a substrate, a polymerizable group, a reactive functionality capable of forming a covalent bond to a substrate, a water-solubilizing group, a group having surfactancy, a dye, or an indicator.

Embodiment 11A. A ligand comprising:
a first anionic functional group that is an arylboronic acid internally complexed with a heteroatom; and
a linker moiety appended to the arylboronic acid, the linker moiety being covalently bonded to a substrate, a polymerizable group, a reactive functional group capable of forming a covalent bond to a substrate, a water-solubilizing group, a group having surfactancy, a dye, or an indicator.

Embodiment 12A. The ligand of Embodiment 11A, wherein the ligand has a structure represented by

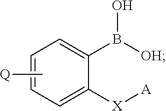

wherein Q is optional aromatic ring substitution, A is the linker moiety, and X is —CH₂NR¹—, —CH₂CH₂NR¹—, —CH₂O—, —CH₂CH₂O—, —C(═O)—, —CH₂C(═O)—, —C(═O)O—, —CH₂CO(═O)O—, —C(═O)NR¹—, —CH₂CO(═O)NR¹—, —NR²C(═O)NR²—, —CH₂NR²C(═O)NR²—, —O(C═O)NR²—, —NR²C(═O)O—, —CH₂NR²C(═O)O—, —NR²S(═O)₂NR²—, —CH₂S(═O)₂NR²—, or S(═O)₂NR²—; wherein R¹ and R² are independently H or an alkyl group.

Embodiment 13A. The ligand of Embodiment 12A, wherein the linker moiety is further covalently bonded to a second anionic functional group.

Embodiment 14A. The ligand of Embodiment 13A, wherein the second anionic functional group comprises a second arylboronic acid, a carboxylic acid, a phosphonic acid, a phosphoramidic acid, or a sulfonic acid.

Embodiment 15A. The ligand of Embodiment 13A, wherein the second anionic functional group comprises a second arylboronic acid group that is internally complexed with a second heteroatom.

Embodiment 16A. The ligand of any one of Embodiments 13A-15A, wherein the ligand has a structure represented by

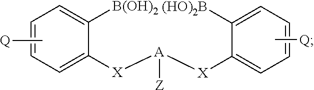

wherein Z is the substrate, the polymerizable group, the reactive functional group capable of forming a covalent bond to a substrate, the water-solubilizing group, the group having surfactancy, the dye, or the indicator

Embodiment 17A. The ligand of Embodiment 16A, wherein Z is the substrate, and the substrate comprises a polymer.

Embodiment 18A. The ligand of Embodiment 17A, wherein the polymer comprises polyglycidyl (meth)acrylate or a copolymer thereof.

Embodiment 19A. The ligand of Embodiment 18A, wherein the polymer defines a plurality of macroparticulates.

Embodiment 20A. The ligand of Embodiment 18A, wherein the polymer defines a thin-film.

Embodiment 21A. A lithium complex comprising a lithium ion, at least one ligand of Embodiments 11-15 complexed with the lithium ion, and up to four water ligands complexed with the lithium ion.

Embodiment 22A. A sensor comprising at least one ligand of Embodiments 11A-15A, wherein the at least one ligand is covalently bonded to a substrate.

Embodiment 23A. A method comprising:
providing one or more ligands comprising a first anionic functional group that is an arylboronic acid internally complexed with a heteroatom;
exposing the one or more ligands to a fluid comprising lithium ions;
forming a complex of the one or more ligands with the lithium ions; and
determining an amount of lithium ions present in the fluid based upon a spectroscopic change or electrochemical change of the one or more ligands in the presence of the lithium ions.

Embodiment 24A. The method of Embodiment 23A, wherein the fluid comprises an aqueous fluid.

Embodiment 25A. A method comprising:
providing one or more ligands comprising a first anionic functional group that is an arylboronic acid internally complexed with a heteroatom;
exposing the one or more ligands to a fluid comprising lithium ions;
forming a complex of the one or more ligands with at least a portion of the lithium ions;
removing the lithium ions from the fluid as the complex.

Embodiment 26A. The method of Embodiment 25A, wherein the one or more ligands are covalently bonded to a substrate.

Embodiment 27A. The method of Embodiment 26A, wherein the substrate comprises a plurality of macroparticulates, a thin-film, or any combination thereof.

Embodiment 28A. The method of any one of Embodiments 25A-27A, wherein the fluid comprises an aqueous fluid.

Embodiment 29A. The method of any one of Embodiments 25A-27A, further comprising:
decomplexing the lithium ions from the one or more ligands; and
optionally, further refining the lithium ions after decomplexing.

Embodiment 30A. The method of Embodiment 29A, wherein decomplexing comprises heating the complex, exposing the complex to an acid, or any combination thereof.

To facilitate a better understanding of the embodiments of the present disclosure, the following examples of preferred or representative embodiments are given. In no way should the following examples be read to limit, or to define, the scope of the disclosure.

### EXAMPLES

### Example 1: Synthesis of 3-((bis(2-aminoethyl)amino)methyl)-1,2-dihydroxyanthracene-9,10-dione (Alizarin-DETA) (Formula 18)

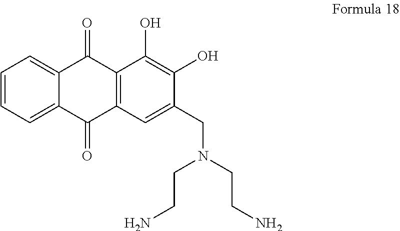 [SMILES: NCCN(CCN)Cc1cc2c(c(O)c1O)C(=O)c1ccccc1C2=O]

The title compound was synthesized by subjecting alizarin to a Mannich reaction. To a 250 mL roundbottom flask were added 4.995 g 1,2-dihydroxyanthracene (alizarin, 20.79 mmol, 1 equiv.) and 1.44691 g formaldehyde (as paraformaldehyde) (45.29 mmol, 2.178 equiv.). The weighing paper was rinsed with water and added to the roundbottom flask, and the reactants were diluted with 50 mL water in total. The reaction mixture was then heated to 75° C. To the heated reaction mixture was added 541.09 mg KOH (8.197 mmol, 0.392 equiv., followed by 2.51 g of diethylenetriamine (2.63 mL, 24.3 mmol, 1.17 equiv.). The reaction mixture turned dark purple when the KOH was added.

After the reaction was complete, the reaction mixture was then diluted with 750 mL deionized water and acidified with 5 M HCl, which resulted in formation of a precipitate. The color changed to yellow upon acidification. The precipitate was found to be unreacted starting material by TLC. After filtration to remove the precipitate, the pH of the filtrate was adjusted to ˜2 with NaOH, and additional precipitation occurred to provide a brown solid. After filtration, the pH of the filtrate was raised to 5.4 with NaOH, which changed the filtrate color to purple.

Water was removed from the filtrate by collecting a benzene-water azeotrope using a Dean-Stark trap. Distillation was continued until no additional water could be collected. A small amount of purple solid precipitated following water removal, and the remaining benzene solution was amber colored. The solid was removed by filtration, and the benzene solution was collected in a 1 L flask. The benzene solution was used without further purification to conduct reductive amination (Example 2).

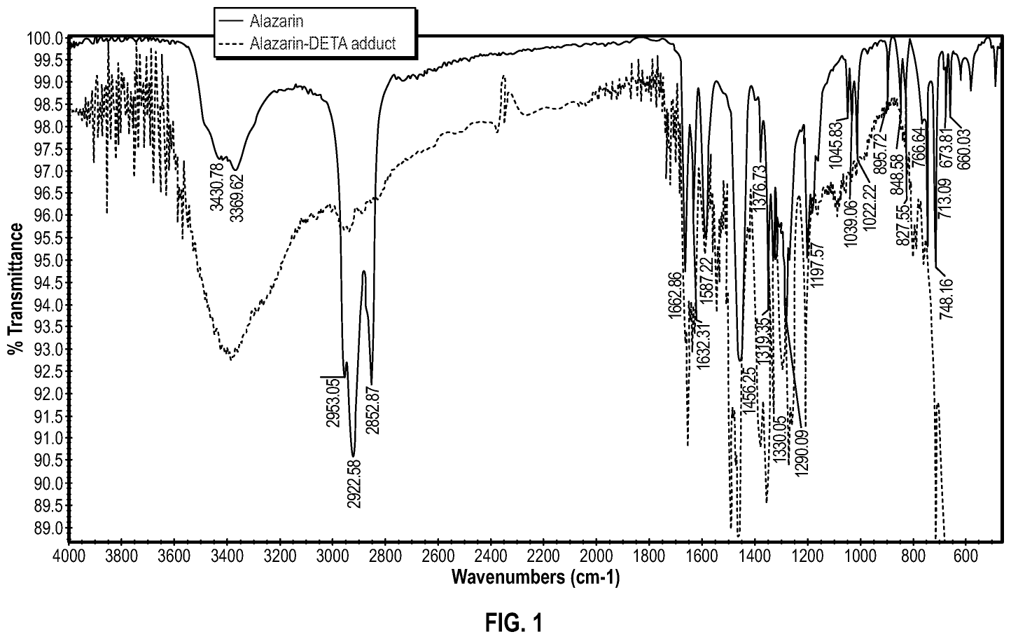

FIG. 1 is an FTIR spectrum of the product obtained from the benzene solution of Example 1 in comparison to that of alizarin.

### Example 2: Synthesis of (((((((3,4-dihydroxy-9,10-dioxo-9,10-dihydroanthracen-2-yl)methyl)azanediyl)bis(ethane-2,1-diyl))bis(azanediyl))bis(methylene))bis(2,1-phenylene))diboronic acid (Alizarin-DETA) (Formula 19)

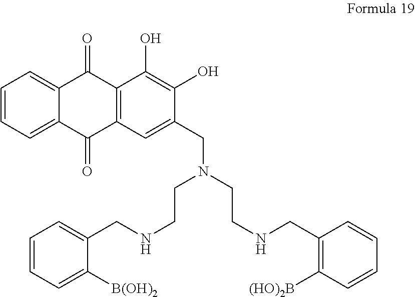 [SMILES: O=C1c2ccccc2C(=O)c2c1cc(CN(CCNCc1ccccc1B(O)O)CCNCc1ccccc1B(O)O)c(O)c2O]

An aliquot of the benzene solution from Example 1 was combined with 304.11 mg of 2-formylphenylboronic acid (1.9674 mmol) and heated to reflux with a Dean-Stark trap. After the 2-formylphenylboronic acid was consumed according to TLC, the reaction mixture was cooled and the benzene solvent was removed in vacuo. Thereafter, the crude imine intermediate was combined with 50 mL methanol and 304.11 mg NaBH₄ (1.9332 mmol). The orange-yellow product was soluble in hot methanol at low concentration and was less soluble in benzene than the Alizarin-DETA precursor (Formula 18).

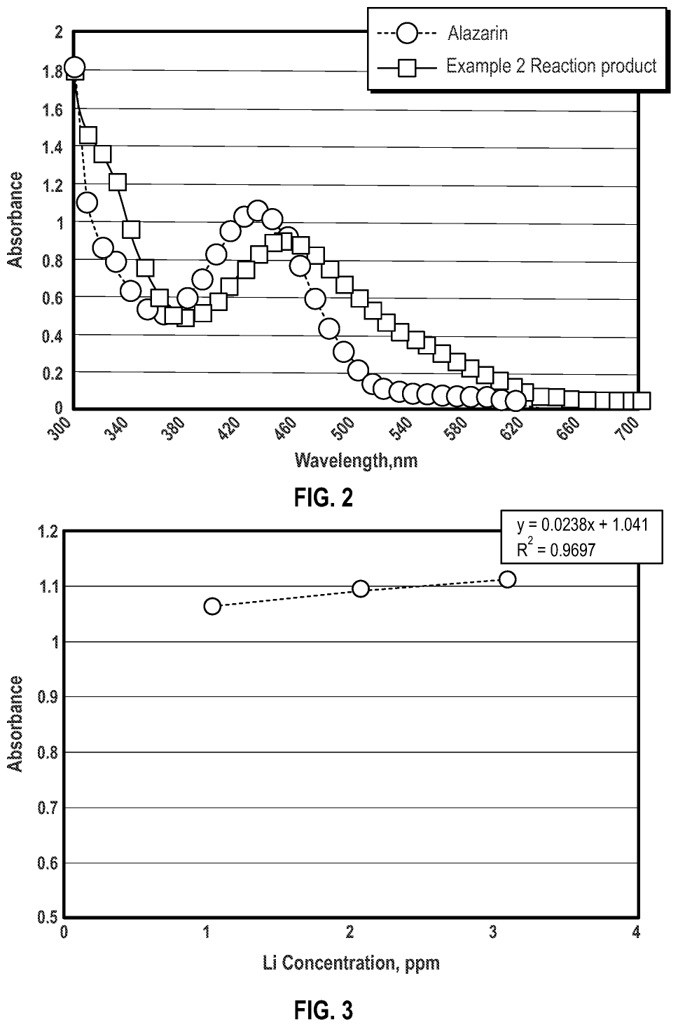

FIG. 2 is a UV-VIS spectrum of the product obtained from the reductive amination reaction of Example 2 in comparison to that of alizarin. As shown, there was a considerable shift in the maximum absorbance as well as stronger absorbance at longer wavelengths.

### Example 3: Lithium Binding

The product of Example 2 was exposed to variable concentrations of Li in water containing an 800-fold excess of Na⁺ to Li⁺ by mass, and the absorbance at a fixed wavelength was measured at each concentration. FIG. 3 is a Beer's Law plot of absorbance as a function of Li⁺ concentration in water in the presence of the product of Example 2. As shown, a near-linear increase in absorbance was observed over the concentration range of 1-3 ppm. The increasing absorbance is consistent with complexation of the lithium by the ligand, thereby promoting a change in the alizarin spectroscopic signature.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form. “from about a to about b.” or, equivalently. “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A lithium complex comprising:
a lithium ion;
one or more ligands comprising at least one anionic functional group and entropically configured to complex the lithium ion; and
optionally, up to four water ligands coordinated to the lithium ion;
wherein:
the one or more ligands are directly coordinated to the lithium ion though one, two, three, or four coordinate covalent bonds via the at least one anionic functional group, each coordinate covalent bond displacing a water ligand from the lithium ion; the at least one ligand is indirectly coordinated to the lithium ion through hydrogen bonding of the at least one anionic functional group with a water ligand; or any combination thereof; and
the one or more ligands and the water ligands complex the lithium ion in a tetracoordinate geometry.

2. The lithium complex of claim 1, wherein the one or more ligands comprise a first anionic functional group that is an arylboronic acid group internally complexed by a heteroatom.

3. The lithium complex of claim 2, wherein the one or more ligands have a structure represented by 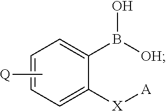
wherein:
Q is optional aromatic ring substitution,
A is an optional linker moiety covalently bonded to at least a second anionic functional group, and
X is —CH₂NR¹—, —CH₂CH₂NR¹—, —CH₂O—, —CH₂CH₂O—, —C(═O)—, —CH₂C(═O)—, —C(═O)O—, —CH₂CO(═O)O—, —C(═O)NR¹—, —CH₂CO(═O)NR¹—, —NR²C(═O)NR²—, —CH₂NR²C(═O)NR²—, —O(C═O)NR²—, —NR²C(═O)O—, —CH₂NR²C(═O)O—, —NR²S(═O)₂NR²—, —CH₂S(═O)₂NR²—, or S(═O)₂NR²—; and
R¹ and R² are independently H or an alkyl group.

4. The lithium complex of claim 3, wherein A is present and is further covalently bonded to a substrate, a polymerizable group, a dye, or an indicator.

5. The lithium complex of claim 3, wherein A is present and the second anionic functional group is a second arylboronic acid internally complexed by a second heteroatom.

6. The lithium complex of claim 1, wherein the at least one ligand is directly complexed to the lithium ion via the at least one anionic functional group, and a number of water ligands displaced from the lithium ion is equivalent to a number of coordinate covalent bonds made by the at least one ligand.

7. The lithium complex of claim 1, wherein the at least one anionic functional group comprises a moiety selected from the group consisting of an arylboronic acid, a carboxylic acid, a sulfonic acid, a phosphonic acid, a phosphoramidic acid, and any combination thereof.

8. The lithium complex of claim 1, wherein the tetracoordinate geometry is tetrahedral or distorted tetrahedral.

9. The lithium complex of claim 1, wherein the tetracoordinate geometry is see-saw or square planar.

10. The lithium complex of claim 1, wherein the one or more ligands are covalently bonded to a substrate, a polymerizable group, a reactive functionality capable of forming a covalent bond to a substrate, a dye, or an indicator.

11. A ligand comprising:
a first anionic functional group that is an arylboronic acid internally complexed by a heteroatom; and
a linker moiety that is covalently bonded to a substrate, a polymerizable group, a reactive functionality capable of forming a covalent bond to a substrate, a dye, or an indicator.

12. The ligand of claim 11, wherein the ligand has a structure represented 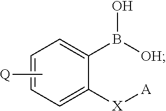
wherein:
Q is optional aromatic ring substitution,
A is an optional linker moiety covalently bonded to at least a second anionic functional group, and
X is —CH₂NR¹—, —CH₂CH₂NR¹—, —CH₂O—, —CH₂CH₂O—, —C(═O)—, —CH₂C(═O)—, —C(═O)O—, —CH₂CO(═O)O—, —C(═O)NR¹—, —CH₂CO(═O)NR¹—, —NR²C(═O)NR²—, —CH₂NR²C(═O)NR²—, —O(C═O)NR²—, —NR²C(═O)O—, —CH₂NR²C(═O)O—, —NR²S(═O)₂NR²—, —CH₂S(═O)₂NR²—, or S(═O)₂NR²—;
R¹ and R² are independently H or an alkyl group.

13. The ligand of claim 12, wherein A is further covalently bonded to a second anionic functional group.

14. The ligand of claim 13, wherein the second anionic functional group comprises a second arylboronic acid, a carboxylic acid, a phosphosphonic acid, a phosphoramidic acid, or a sulfonic acid.

15. The ligand of claim 13, wherein the second anionic functional group comprises a second arylboronic acid group that is internally complexed with a second heteroatom.

16. The ligand of claim 13, wherein the ligand has a structure represented by 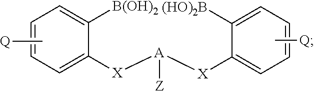
wherein Z is the substrate, the polymerizable group, the reactive functionality, the dye, or the indicator.

17. The ligand of claim 16, wherein Z is the substrate, and the substrate comprises a polymer.

18. The ligand of claim 17, wherein the polymer comprises polyglycidyl (meth)acrylate or a copolymer thereof.

19. The ligand of claim 18, wherein the polymer defines a plurality of macroparticulates.

20. The ligand of claim 18, wherein the polymer surface defines a thin film.

21-30. (canceled)
